(19) United States
(12) Patent Application Publication
(10) Pub. No.: US 2017/0098425 A1
(43) Pub. Date: Apr. 6, 2017

(54) VEHICLE DISPLAY APPARATUS

(71) Applicant: YAZAKI CORPORATION, Tokyo (JP)

(72) Inventors: Masahiro Takamatsu, Shizuoka (JP); Masahide Nagata, Shizuoka (JP); Takao Kanai, Shizuoka (JP)

(21) Appl. No.: 15/284,167

(22) Filed: Oct. 3, 2016

(30) Foreign Application Priority Data
Oct. 6, 2015 (JP) 2015-198518

(51) Int. Cl. G09G 5/00; B60K 37/02; G09G 5/38

(52) U.S. Cl. CPC G09G 5/003; G09G 5/38; B60K 37/02; G06F 1/1603

(57) ABSTRACT

A vehicle display apparatus includes a display part for use in a vehicle and displaying information; and a cover part capable of switching its state between a first state not allowing the display part to be visually recognized by a vehicle driver and a second state allowing the display part to be visually recognized by the vehicle driver.

### CROSS-REFERENCES TO RELATED APPLICATION(S)

This application is based on and claims priority from Japanese Patent Application No. 2015-198518 filed on Oct. 6, 2015, and the entire contents of which are incorporated herein by reference.

### BACKGROUND

Field of the Invention

The invention relates to a vehicle display apparatus for displaying various kinds of information.

Description of Related Art

Vehicle display apparatuses are conventionally used to supply various kinds of information to vehicle drivers. For example, one of conventional vehicle display apparatuses (hereinafter referred to as a “conventional apparatus”) is arranged in an instrument panel (which is also called a dashboard) as a part of a meter panel, and includes various display lamps for displaying the states of a vehicle (for example, a display lamp for notifying abnormal states of an ABS and a power steering and so on, and a display lamp for notifying the un-mounted state of a seat belt). In the conventional apparatus, the display lamps are turned on depending on the states of the vehicle to provide the driver with necessary information.

As for details of the conventional example, refer to JP 2012-250609 A.

### SUMMARY

The various display lamps of the conventional apparatus are designed to be turned on when pertinent information must be supplied to the driver (for example, when various abnormal states occur). However, since the display lamps of the conventional apparatus are generally formed on the surface of the meter panel in a translucent manner, even when not turned on (that is, even when the pertinent information need not be supplied to the driver), they can be visually recognized by the driver. In other words, the display lamps of the conventional apparatus can always be visually recognized by the driver.

Then, in the conventional apparatus, even in the case that the display lamps turn on when it is necessary to supply the driver with the information, such turn-on cannot arouse the attention of the driver sufficiently (for example, it lacks novelty and thus the driver is not surprised at it), thereby failing to attain its original object that it supplies the driver with the information. Also, since the display lamps can always be visually recognized by the driver, the beauty of the instrument panel can also be spoiled.

In addition, the above problems can occur not only in the conventional apparatus but also in other ordinary vehicle display apparatuses. For example, even when a head-up display (hereinafter referred to as HUD) is used as the other ordinary vehicle display apparatus, it is necessary to form in the instrument panel an opening or the like for releasing a display image supplied from the display device (light source) of HUD to the outside of the instrument panel. Accordingly, similarly to the above, whether display is present or not, such opening can always be visually recognized by the driver. Thus, similarly to the above, the information to be supplied to the driver cannot be displayed with high visual recognition, and the beauty of the instrument panel of the vehicle can also be spoiled.

It is an object of the present invention, in view of the above problems, to provide a vehicle display apparatus which, without spoiling the beauty of the instrument panel of the vehicle as much as possible, is capable of displaying information to be supplied to the driver with high visual recognition.

Vehicle display apparatuses according to the invention include the following items (1) to (6).

(1) A vehicle display apparatus comprising:

a display part for use in a vehicle and displaying information; and

a cover part capable of switching its state between a first state not allowing the display part to be visually recognized by a vehicle driver and a second state allowing the display part to be visually recognized by he vehicle driver.

(2) The vehicle display apparatus according to claim 1, wherein

the cover part constitutes a part of a surface of an instrument panel of the vehicle and is capable of moving within a range from a first position where the surface and the cover part form a single flat surface to a second position where at least a portion of the cover part is separated from the surface, and

the display part is in the first state upon the cover part being at the first position and in the second state upon the cover part being at the second position, the display part directing its display surface in a direction corresponding to a viewpoint position of the vehicle driver upon being in the second state.

(3) The vehicle display apparatus according to claim 2, wherein

the display part is stored into the instrument panel to be in the first state upon the cover part being at the first position, and the display part is exposed from the instrument panel to be in the second state upon the cover part being at the second position.

(4) The vehicle display apparatus according to claim 1, wherein

the vehicle display apparatus determines, when the display part is in the first state, whether to switch the display part into the second state depending on the information to be displayed on the display part.

(5) The vehicle display apparatus according to claim 4, wherein

the vehicle display apparatus determines to switch the display part into the second state when the information to be displayed on the display part is emergency information regarding an emergent state of the vehicle.

(6) The vehicle display apparatus according to claim 2, wherein

at least one of a position of the display part and a position of the cover part is adjusted to direct the display surface in the direction corresponding to the viewpoint position of the vehicle driver.

According to the configuration of the above item (1), the state of the display part can be switched from the first state to the second state by operating the cover part as needed. Thus, for example, supposing the cover part has a shape or a structure (for example, a structure in which the cover part is formed integrally with the surface of an instrument panel, or a structure in which the shape of the cover part formed similar to the fin of an air blow-out opening for an air conditioner) hard to attract the attention of the driver, when the display part provides the first state, the existence of the display part itself can be made hard to be recognized by the driver. In other words, the display part can be hidden.

Further, when the thus hidden display part is switched from the first state to the second state, the display part appears suddenly in the eyesight of the driver. In other words, when the vehicle display apparatus is switched from a state (first state) where it is not used over to a state (second state) where it is used, the driver recognizes the display part with surprise and originality, for example, as if the display panel appears suddenly from a normal instrument panel. Thus, when compared with a case where the display part is always visually recognized, the attention of the driver is aroused more strongly.

Accordingly, the vehicle display apparatus of this structure is capable of displaying the information to be notified to the driver with high visual recognition without impairing the beauty of the instrument panel of the vehicle as much as possible.

According to the configuration of the above item (2), the display part can be switched from the first state to the second state by moving the cover part from the first position to the second position as needed. Further, while the information is being displayed (while the cover part is existing at the second position), the display surface of the display part is directed toward the visual position of the driver, thereby enabling recognition of the display part with high visual recognition. Accordingly, the vehicle display apparatus of this structure is capable of displaying the information to be notified to the driver with high visual recognition without impairing the beauty of the instrument panel of the vehicle as much as possible.

In addition, the above description “the display surface is directed toward the viewpoint position of the driver” may be performed by one or both of the two following operations: that is, one operation to direct the display part from the previously assumed position of the head of the driver to a viewpoint position previously designed or estimated (no posterior adjustment is performed); and the other operation to measure the actual position of the head of the driver and direct the display part from the measured head position to a specified viewpoint position (posterior adjustment is performed). Specific methods are not limitative.

According to the configuration of the above (3), as the cover part moves, the display part is stored or exposed. Accordingly, in the vehicle display apparatus of this structure, when the cover part exists at the first position, the display part can be surely set in a visually unrecognizable state (first state) and, when the cover part exists at the second position, the display part can be surely set in a visually recognizable state (second state).

According to the configuration of the above (4), the state (first or second state) of the display part can be controlled in consideration of the importance or the like of the information to be displayed on the display part. Accordingly, when compared with a case where the display part is switched from the first state to the second state without such consideration (for example, in the engine start time, when the cover part is always moved from the first position to the second position), the attention of the driver is attracted easily. Thus, the vehicle display apparatus of this structure enables the driver to recognize the information to be notified to the driver more positively.

According to the configuration of the above (5), in emergencies (for example, when a collision must be avoided, and when the speed exceeds a given limit value), the state of the display part can be switched from the first state to the second state (for example, the cover part is moved from the first position to the second position). Thus, for example, the cover part in the first state (for example, it exists at the first position and is closed) in a normal time is moved to the second state in emergencies (for example, it is moved to the second position and is opened). Accordingly, the vehicle display part of this structure is capable of arouse the attention of the driver and thus is capable of make the driver recognize the information to be notified to the driver (emergency information) more positively.

In addition, the above-mentioned term “the information expressing the emergent state of the vehicle” can also be expressed as the information of high emergency to be notified to the driver. For example, information expressing that the possibility of the collision of the vehicle with an object or the like existing ahead of the vehicle is high; information expressing that the speed of the vehicle exceeds a specific limit value; information expressing occurrence of abnormality in various equipment of the vehicle; and, information expressing recognition of driver's sleeping.

According to the configuration of the above (6), the visual recognition of information is enhanced further. For example, when the display part is capable of be moved (inclined) independent of the cover part, by adjusting the position (inclination angle) of the display part with the cover part remaining fixed, the display surface is directed in a direction corresponding to the viewpoint position of the driver. Also, when the display part is fixed to the cover part, by adjusting the position of the cover part, the display surface is directed in a direction corresponding to the viewpoint position of the driver.

According to the invention, using the cover part, the visually recognizable state and the visually unrecognizable state of the display part can be switched over to each other. As a result, when compared with the conventional apparatus, the vehicle display apparatus of the invention can display the information to be notified to the driver with surprise and originality without impairing the beauty of the instrument of the vehicle as much as possible.

The invention is briefly described above. Furthermore, some embodiments of the invention will be described below with some drawings to give clear details of the invention.

### BRIEF DESCRIPTION OF THE DRAWINGS

FIG. 1 is a schematic view of the neighborhood of an instrument panel including a display device according to a first embodiment of the invention when the interior of the compartment of the vehicle on the driver seat side is viewed from the lateral side thereof.

FIG. 2 is a schematic perspective view of the appearance of the display apparatus according to the first embodiment of invention.

FIG. 3 is a schematic view of a drive mechanism for driving the display apparatus.

FIG. 4 is a block diagram of the structure of a control unit.

FIG. 5 is a flow chart of a procedure for driving the display apparatus.

FIG. 6A is a front view of the appearance of the instrument panel neighborhood of a vehicle while the display apparatus is opened, and FIG. 6B is a front view of the appearance of the vehicle instrument panel neighborhood while the display apparatus is closed.

FIG. 7 is a schematic perspective view of the appearance of a display apparatus according to a second embodiment.

FIG. 8 is a schematic perspective view of the appearance of a display apparatus according to a third embodiment.

FIG. 9 is a schematic perspective view of the appearance of a display apparatus according to a fourth embodiment.

FIG. 10 is a schematic perspective view of the appearance of a display apparatus according to a fifth embodiment.

FIG. 11 is a schematic perspective view of the appearance of a display apparatus according to a sixth embodiment.

FIG. 12 is a schematic view of a drive mechanism for a display apparatus in which a cover part and a display are connected to each other.

### DETAILED DESCRIPTION

### First Embodiment

Configurations of a vehicle display apparatus according to a first embodiment of the invention (hereinafter referred to as “display apparatus 10”) will hereinafter be described with reference to drawings.

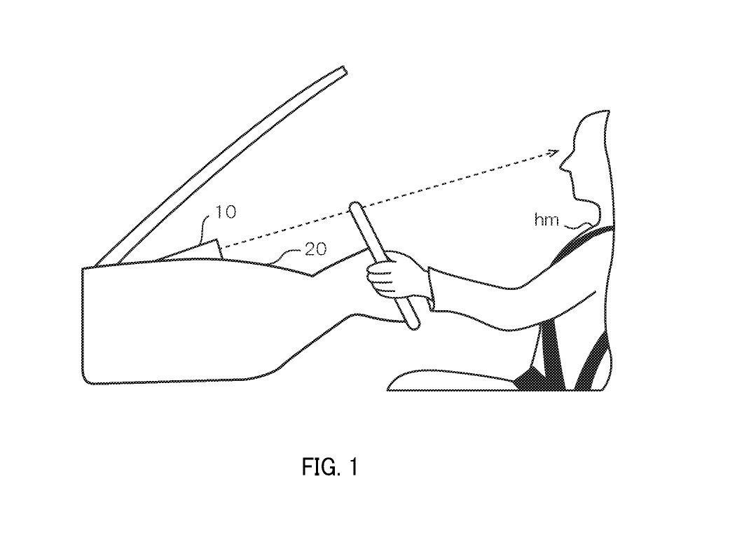

As shown in FIG. 1, the display apparatus 10 is arranged on the vehicle front side upper surface of an instrument panel 20 so as to face a driver hm seated on a driver seat.

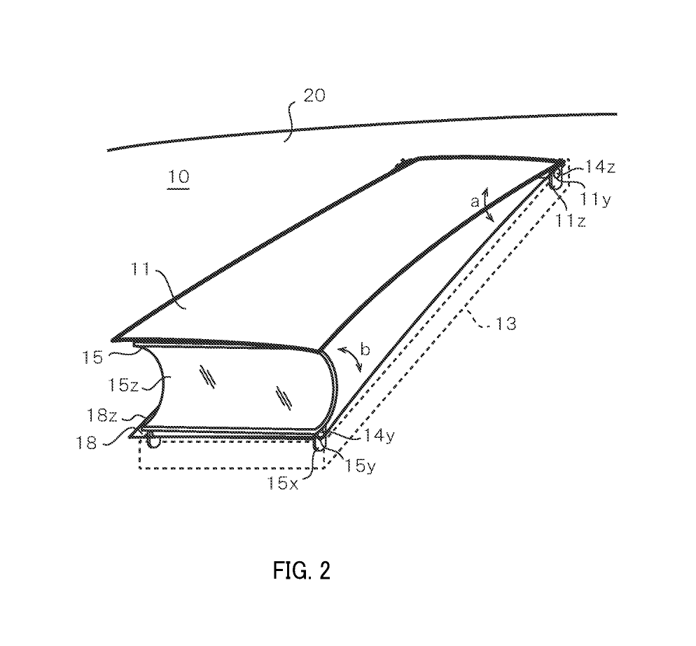

As shown in FIG. 2, the display apparatus 10 is embedded into the instrument panel 20. It includes a box body 13 having a recess 18 with an opening 18z formed in the (front) surface thereof, a cover part 11 capable of opening and closing the opening 18z, and a display (display part) 15 stored in the recess 18. The cover part 11 is structured as a part of the surface of the instrument panel 20 and, when it is closed so as to cover the opening 18z, it is united with the remaining parts of the instrument panel 20 to thereby form the surface of the instrument panel 20 (that is, it is flush with the panel 20).

In the vehicle front side end of the cover part 11 (in FIG. 2, the back-side end. It is hereinafter referred to as “the front end of the cover part 11”), there is arranged a hinge mechanism constituted of a rotation shaft 14z supported horizontally on the wall surface of the recess 18 and a projection piece 11z projected from the front end of the cover part 11 and having a hole 11y for insertion of the rotation shaft 14z.

This hinge mechanism enables the cover part 11 to rotate about the rotation shaft 14z in the direction of the arrow a shown in FIG. 2. When the cover part 11 rotates, the vehicle rear-side end of the cover part 11 (in FIG. 2, the front-side end. It is hereinafter referred to as “the rear end of the cover part 11”) is moved within a range from a position (first position) flush with the remaining parts of the instrument panel 20 to a position (second position) where it is lifted (separated) up from the remaining parts of the instrument panel 20. In other words, the display apparatus 10 can be switched over between a closed state and an opened state.

In the vehicle lower side end of the display 15 (in FIG. 2, the lower side end. It is hereinafter referred to as “the lower end of the display part 15”), there is arranged a hinge mechanism constituted of a rotation shaft 14y supported horizontally on the wall surface of the recess 18 and a projection piece 15x projected from the lower end of the display 15 and having a hole 15y for insertion of the rotation shaft 14y.

This hinge mechanism enables the display 15 to rotate about the rotation shaft 14y in the direction of the arrow b shown in FIG. 2. Thus, the display 15 can be moved with the movement of the cover part 11. Specifically, when the display apparatus 10 changes from the closed state to the opened state, the display 15 stored in the recess 18 is exposed therefrom. And, when the display 15 rotates, the upper part of the display 15 rises, whereby a display surface 15z can be visually recognized from the driver seat side. The details of this rotation operation are described later.

The display surface 15z of the display 15 has a curved shape curved inward (toward the vehicle front side. In FIG. 2, toward the back side). Thus, in the raised state of the display 15, even when the viewpoint position of the driver hm seated on the driver seat is slightly shifted in the vertical direction, the visually recognizable state of the display surface 15z can be maintained.

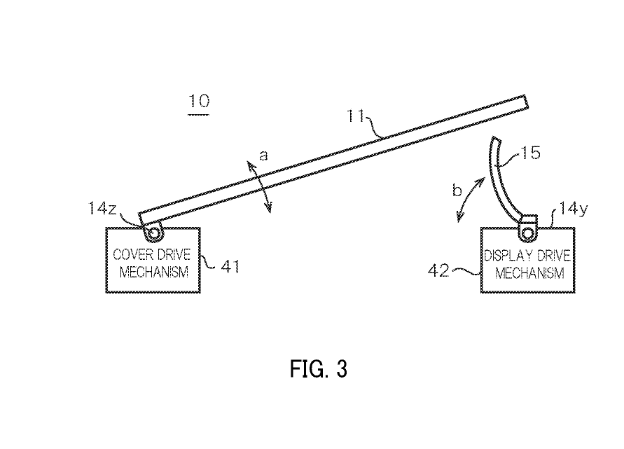

As shown in FIG. 3, the display apparatus 10 includes a cover drive mechanism 41 for rotating the cover part 11 about the rotation shaft 14z in the arrow a direction, and a display drive mechanism 42 for rotating the display 15 about the rotation shaft 14y in the arrow b direction. The cover drive mechanism 41 incorporates therein a motor and a gear and, using the drive force of the motor, drives the gear with the rotation shaft 14z supported thereon to thereby rotate the cover part 11 together with the rotation shaft 14z. Similarly, the display drive mechanism 42 incorporates therein a motor and a gear and, using the drive force of the motor, drives the gear with the rotation shaft 14y supported thereon to thereby rotate the display 15 together with the rotation shaft 14y.

The cover drive mechanism 41 and display drive mechanism 42 may also be controlled by a control unit (including ECU) or the like for controlling a panel meter and the like arranged in the instrument panel 20, or may also be controlled by a control unit designed exclusively for the display apparatus 10. In any case, the control unit receives, through an onboard network or the like, operation data representing the operation states of the vehicle (for example, speeds, G values (acceleration) and vehicle distances), and transmits control signals to the cover drive mechanism 41 and display drive mechanism 42.

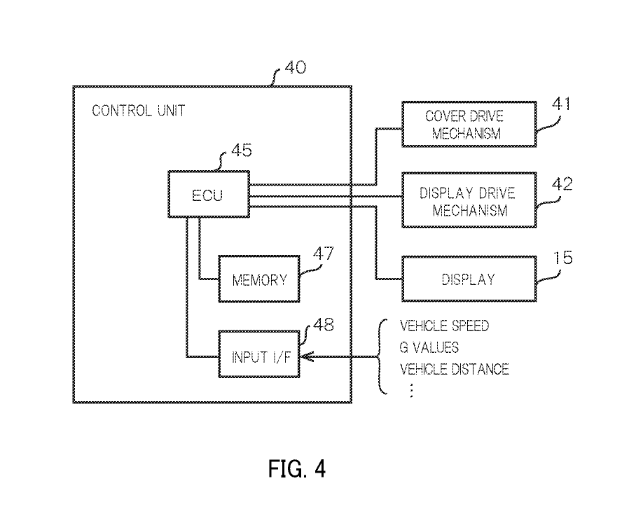

FIG. 4 shows an example for controlling the cover drive mechanism 41, display drive mechanism 42 and so on using a control unit exclusively designed for the display apparatus 10. The display apparatus 10 mounts a control unit 40 thereon. The control unit 40 includes an ECU 45, a memory 47 and an input I/F 48. ECU 45 incorporates therein a CPU, a ROM and so on and integrally controls the respective parts of the display apparatus 10. To ECU 45, there are connected the memory 47, input I/F 48, display 15, cover drive mechanism 41 and display drive mechanism 42.

The memory 47 stores operation programs, display data and so on to be executed by ECU 45. The display data include, for example, information (such as a danger mark) expressing a high possibility of the vehicle colliding with an object or the like existing ahead of it, and information (such an “over-speed” text) expressing that the speed of the vehicle has exceeded a specific limit value. The memory 47 stores a display angle corresponding to the viewpoint position of the driver hm seated on a driver seat. Into the input I/F 48, there are input operation data such as vehicle speed, G values and vehicle distances measured by other control units.

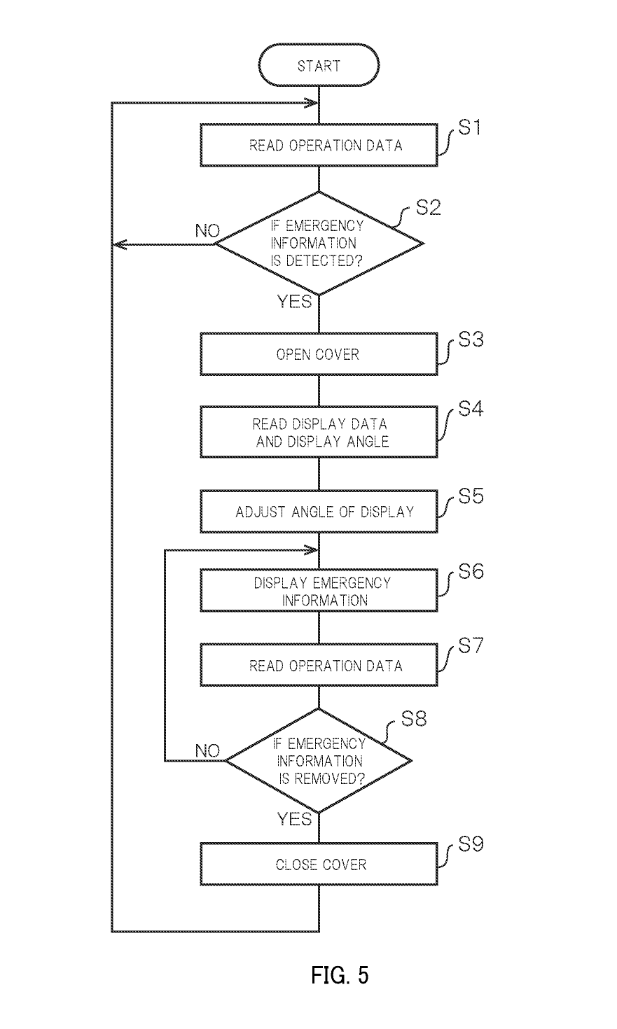

Referring to a flow chart of FIG. 5, description is given of steps in which the display apparatus 10 displays information (emergency information) expressing the emergent state of the vehicle. However, the emergency information is nothing but convenience' sake information for explaining an example of the operation of the display apparatus 10, while the display apparatus 10 can also be structured such that it displays information (for example, vehicle speed information and navigation information) different from the emergency information.

First, in Step S1, ECU 45 inputs operation data such as vehicle speeds, G values and vehicle distances through the input I/F 48.

Next, in Step S2, ECU 45 checks according to the operation data whether information (emergency information) expressing the emergent state of the vehicle has been detected or not. When not detected, ECU 45 determines “No” in Step S2 and returns to the processing of Step S1. When detected, ECU 45 determines “Yes” in Step S2 and advances to Step S3, where it drives the cover drive mechanism 41 to start a lift-up operation for opening the cover part 11.

Next, in Step S4, ECU 45 reads display data corresponding to the emergency information stored in the memory 47 and a target display angle corresponding to the viewpoint position of the driver hm seated on the driver seat. In addition, the viewpoint position of the driver hm may also be: a viewpoint position previously designed (estimated) from the previously assumed position of the head of the driver hm (no posterior adjustment is performed); or, a viewpoint position operated specifically from the actual position of the head of the driver hm measured using a camera or the like (posterior adjustment is performed).

Next, in Step S5, ECU 45 performs a wakeup operation to stand up the display 15 using the display drive mechanism 42, thereby adjusting the angle of the display 15 such that the actual display angle coincides with the above-mentioned target display angle. That is, through Steps S3 to S5, the display 15 is switched into a state where it “can be visually recognized” by the driver hm.

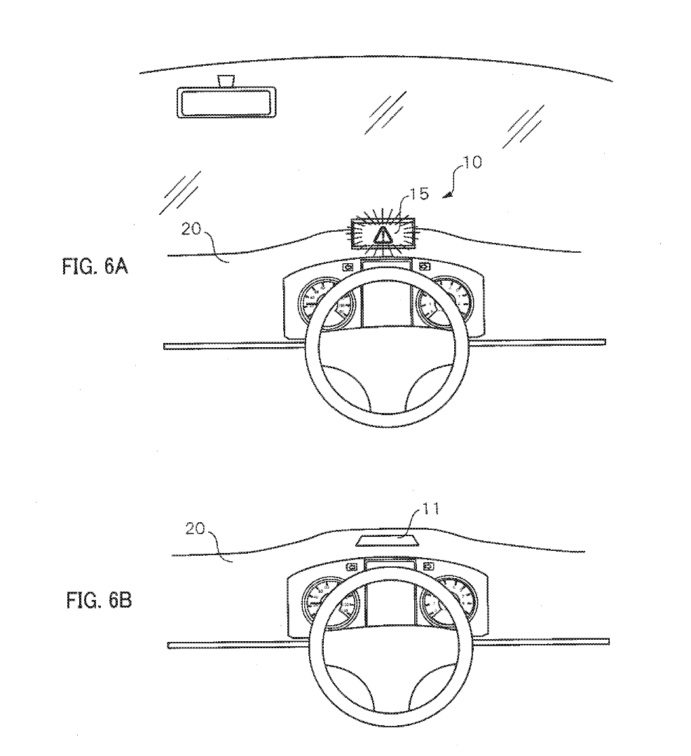

Next, in Step S6, after the cover part 11 opens and after the display stands up, ECU 45 controls the display 15 to display the emergency information (see FIG. 6A as well). In addition, ECU 45 enables the display 15 to display the emergency information even while the cover part 11 is opening or while the display 15 is standing up.

As shown in FIG. 6A, the rear end (in FIG. 6A, this side end) of the cover part 11 of the display apparatus 10 lifts up and the display 15 stands up, whereby the emergency information (in the example, a danger mark) displayed on the display surface 15z is visually recognized by the driver hm.

Next, in Step S7, ECU 45 receives again the operation data through the input I/F 48. And, in Step S8, it checks according to the operation data input through the input I/F 48 whether the emergent state of the vehicle is removed or not. For example, when not removed, ECU 45 determines “No” in Step S8 and returns to Step S6. Meanwhile, when removed, it advances to Step S9, where it controls the cover drive mechanism 41 to start to close the cover part 11 and also controls the display drive mechanism 42 to start to incline the display 15. On completion of the closing operation of the cover part 11, the cover part 11 provides a part of the instrument panel 20 and thus becomes flush with it, whereby the display apparatus 10 is hard to be seen (see FIG. 6B). That is, the display 15 is turned into a state where it “cannot be visually recognized” by the driver hm.

As shown in FIG. 6B, when the display apparatus 10 is stored such that it is embedded in the instrument panel 20, the display 15 cannot be visually recognized from the driver hm. This can keep the beauty of the instrument panel 20.

After then, ECU 45 returns to the processing of Step S1 and repeats the above-mentioned routine.

Thus, by moving the cover part 11 from the storage position (first position) to the lift-up position (second position), the display 15 (display part) turns from the visual recognition disabling state to the visual recognition enabling state. This makes the driver hm recognize the display 15 (display part) with surprise and originality as if it appears suddenly from the normal instrument panel 20. Further, since the display surface 15z goes toward the viewpoint position of the driver hm, the visual recognition performance of information displayed on the display 15 is enhanced. Thus, display apparatus 10 can display the information to be transmitted to the driver hm with high visual recognition performance without impairing the beauty of the instrument panel 20 of the vehicle as much as possible.

Further, while the importance of the information to be displayed on the display 15 (in this example, whether it is emergency information or not) is taken into consideration, the movement of the cover part 11 can be controlled. Thus, when compared with a case where the cover part 11 is moved from the first position to the second position without such consideration (for example, always in the engine starting time), it is easy to attract the attention of the driver hm. Specifically, the cover part 11, which exists in the first position in the normal time (while it is closed), in an emergency, is moved (opened) to the second position. Thus, the display apparatus 10 allows the driver hm to recognize more positively the information to be transmitted to the driver hm.

Further, since the display 15 can be inclined independently of the cover part 11, the position (inclination angle) of the display 15 can be adjusted while the cover part 11 remains fixed. This enables further enhancement in information visual recognition performance.

### Second Embodiment

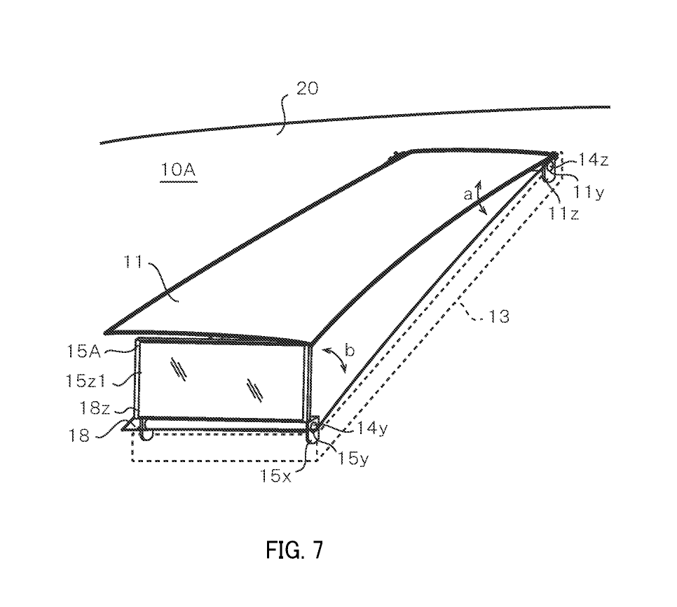

Next, referring to FIG. 7, description is given of a vehicle display apparatus (hereinafter referred to as “display apparatus 10A”) according to a second embodiment of the invention.

In the display apparatus 10 of the first embodiment, the display surface 15z of the display 15 has a curved shape. Meanwhile, in the display apparatus 10A of the second embodiment, the display surface 15z1 of the display 15A has a flat shape.

Since the structure of the display apparatus 10A is substantially the same as that of the display apparatus 10 of the first embodiment, the same composing elements as the display apparatus 10 are given the same designations and thus the description thereof is omitted. This applies similarly to the third to sixth embodiments of the invention.

As shown in FIG. 7, in the display apparatus 10A, the display surface 15z1 of the display 15A is a flat surface (plane). In this case as well, the display surface 15z1 of the display 15A may be directed toward a previously determined viewpoint position (no posterior adjustment is performed), or may be directed toward a viewpoint position measured using a camera or the like (posterior adjustment is performed).

For example, ECU 45 can be structured such that it controls the display drive mechanism 42 to adjust the angle (inclination from a horizontal surface) of the display surface 15z1, whereby a direction (hereinafter referred to as “display direction”) perpendicular to the display surface 15z1 is matched to a direction (eye direction) corresponding to the viewpoint position of the driver hm. Specifically, ECU 45 may also control the display drive mechanism 42 such that the viewpoint position of the driver hm is repeatedly detected using a camera or the like to obtain information about the real-time detected viewpoint position of the driver hm, thereby always causing the display direction to provide the viewpoint direction of the driver hm. Thus, the angle of the display surface 15z1 can be adjusted correspondingly to the movement of the viewpoint position of the driver hm, thereby enabling enhancement in information visual recognition performance.

### Third Embodiment

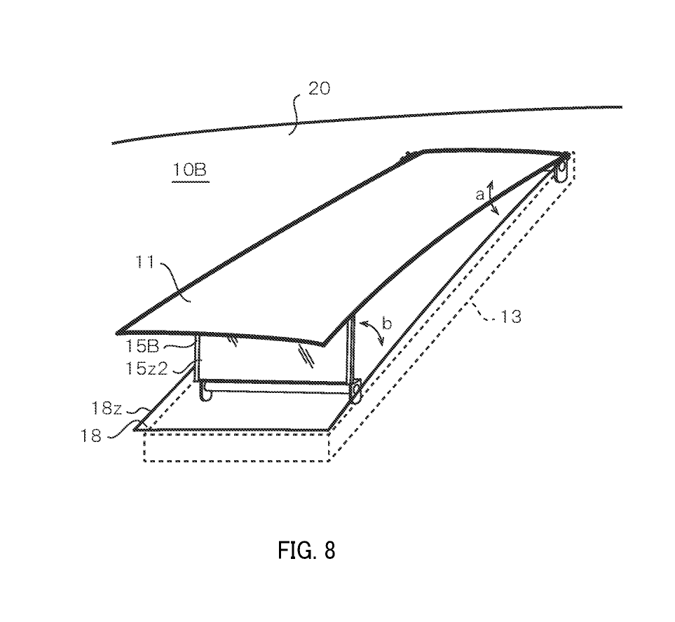

Next, description is given of a vehicle display apparatus according to a third embodiment of the invention (hereinafter referred to as “display apparatus 10B”) with reference to FIG. 8.

As shown in FIG. 8, in the display apparatus 10B, similarly to the display apparatus 10A of the second embodiment, the display surface 15z2 of the display 15B is a plane. Meanwhile, the display 15B is arranged at a position existing forwardly (in FIG. 8, on the back side) of the rear end (in FIG. 8, on this side) of the cover part 11.

The arrangement of the display 15B at such position enables the cover part 11 to prevent an external light from entering the display 15B, whereby the periphery of the display 15B becomes dark. Thus, the brightness of an image displayed on the display surface 15z2 becomes relatively larger than that of the periphery thereof, thereby enabling enhancement in information visual recognition performance.

In the above-mentioned first to third embodiments, description has been given of the structure in which, by opening and closing the cover part 11 forming a part of the surface of the instrument panel 20, the displays 15, 15A and 15B are switched over between the visually recognizable state (first state) and the visually unrecognizable state (second state). Next, description is given of embodiments (fourth to sixth embodiments) in which first and second states are switched over to each other using a mechanism different from that of the first to third embodiments.

### Fourth Embodiment

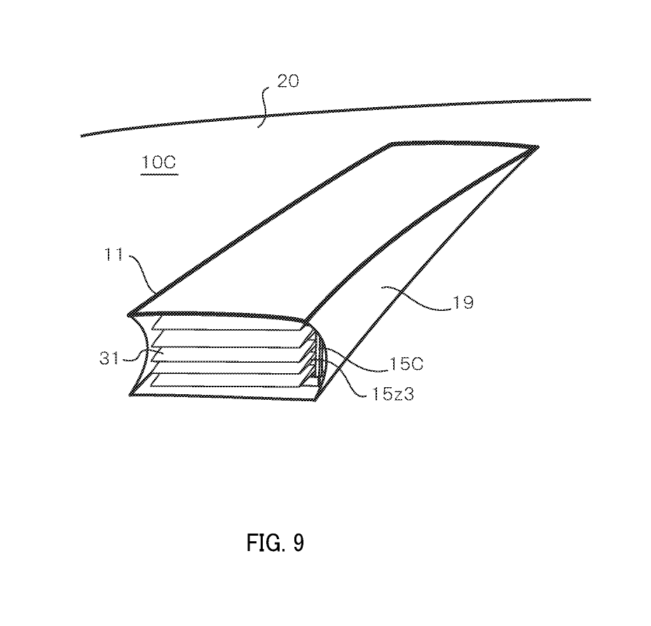

Description is given of a vehicle display apparatus (hereinafter referred to as a “display apparatus 100”) according to a fourth embodiment of the invention with reference to FIG. 9.

In the display apparatus 100, differently from the first to third embodiments, the cover part 11 is immovably fixed to the instrument panel 20. And, instead of the movement of the cover part 11 in the first to third embodiments, multiple fins 31 arranged before the display surface 15z3 of the display 15C can be rotated. Due to the rotation of the multiple fins 31, the first and second states can be switched over to each other.

Specifically, in the display apparatus 100, the display surface 15z3 of the display 15C is a plane and the multiple fins 31 are arranged before the display surface 15z3. The display 150 is arranged within a space surrounded by the cover part 11, a lateral wall surface 19 and the surface of the instrument panel 20.

The inclination (fin angle) of the multiple fins 31 can be changed by a drive mechanism (not shown) such as a motor and a gear. And, similarly to the first embodiment (see the flow chart of FIG. 5), on detecting information (emergency information) expressing the emergent state of the vehicle, the inclination (fin angle) of the multiple fins 31 is adjusted such that the target fin angle of the fins 31, which provides a fin angle obtained when the display surface 15z3 of the display 15C is visually recognized by the driver hm, coincides with the actual fin angle of the fins. Meanwhile, when the emergent state is removed, the inclination of the multiple fins 31 is adjusted such that the display surface 15z3 of the display 150 provides a fin angle (for example, a fin angle where the fins 31 are inclined most in the vehicle downward direction) which cannot be visually recognized by the driver hm.

In addition, the target fin angle, similarly to the first embodiment, may be a fin angle previously designed (estimated) from the previously assumed position of the head of the driver hm (no posterior adjustment is performed), or may be a fin angle specified from the actual position of the head of the driver hm measured using a camera or the like (posterior adjustment is performed).

In addition, the fins 31 may be arranged in parallel (transversely) to the surface of the instrument panel 20 as shown in FIG. 9, or may be arranged perpendicularly (vertically) to the surface of the instrument panel 20.

### Fifth Embodiment

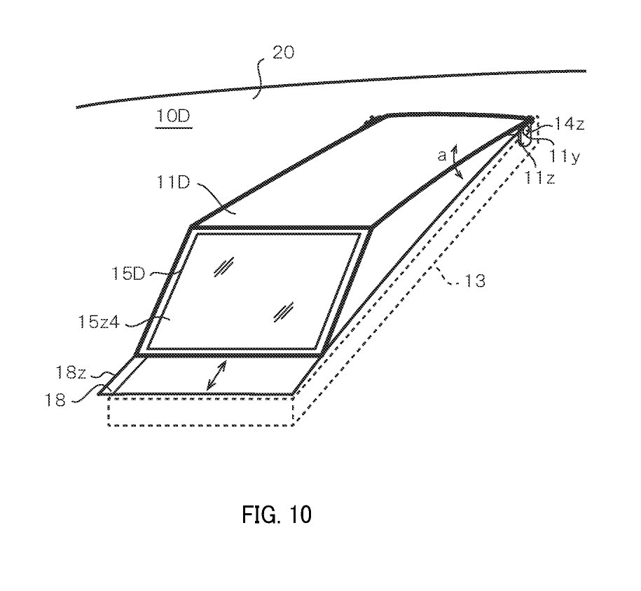

Next, description is given of a vehicle display apparatus (hereinafter referred to as a “display apparatus 100”) according to a fifth embodiment of the invention with reference to FIG. 10.

As shown in FIG. 10, the display apparatus 10D has a foldable structure in which, when the cover part 11D rotates about the front end thereof (in FIG. 10, the back-side end), the cover part 11D is raised in an angular shape.

The cover part 11D is structured such that the neighborhood of the central portion thereof can be folded. In the surface of the cover part 11D on this side in FIG. 10, there is formed a slight recess, and the display 15D is arranged to be stored within the recess. Thus, while the cover part 11D is closed, the surface of the cover part 11D becomes substantially flush with the surfaces of the remaining portions of the instrument panel 20. Meanwhile, when the cover part 11D is folded into an angular shape, it is moved toward the back side in FIG. 10 in such a manner that this side portion thereof slides on the peripheral edge portion of the opening 18z.

Thus, the inclination of the surface 15z4 of the display 15D is changed, thereby enabling adjustment of the display direction in the eye direction of the driver hm. Also, while the cover part 11D is closed, the display direction of the display 15D is substantially perpendicular to the surface of the instrument panel 20, thereby substantially disabling the driver hm to visually recognize the display surface 15z4 of the display 150. Further, in this state, nothing is displayed on the display 15D. That is, the display 15D is in a state where it substantially “cannot be visually recognized” by the driver hm.

In addition, when the cover part 11D is closed, an image of the same color or the same pattern as the instrument panel 20 may also be displayed on the display 15D. This can make it harder for the driver hm to visually recognize the display 15D. Further, the cover part 11D may also be moved slightly downward in FIG. 10 to thereby direct the display direction of the display 15D forwardly of the vehicle. This makes it still harder for the driver hm to visually recognize the display surface 15z4 of the display 15D.

### Sixth Embodiment

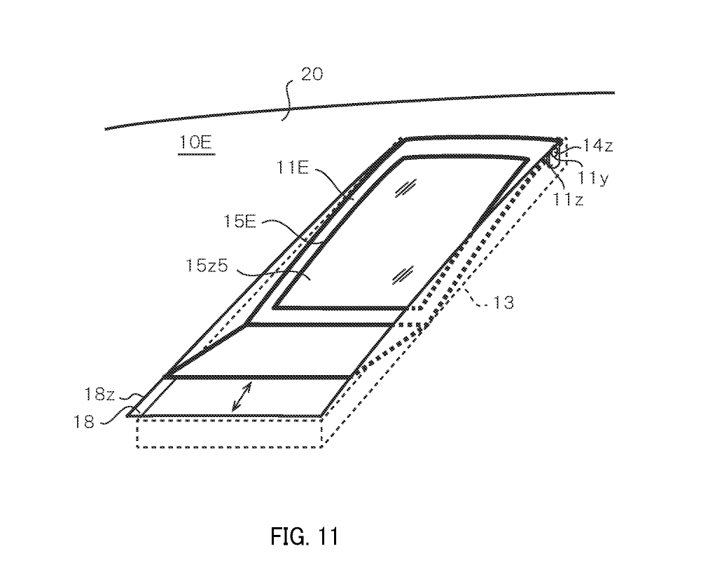

Next, description is given of a vehicle display apparatus (hereinafter referred to as a “display apparatus 10E”) according to a sixth embodiment of the invention with reference to FIG. 11.

As shown in FIG. 11, the display apparatus 10E has a structure substantially similar to the display apparatus 10D of the fifth embodiment. However, the display apparatus 10E has such a foldable structure that the cover part 11E can be recessed into a valley shape.

The cover part 11E has a slight recess in the surface thereof and the display 15E is arranged to be stored within the recess. Thus, while the cover part 11E is closed, the surface of the cover part 11E becomes substantially flush with the surface of the instrument panel 20. Also, when the cover part 11E is folded into a valley shape, it is moved toward the back side in FIG. 11 in such a manner that this side portion thereof slides on the peripheral edge of the opening 18z.

This changes the inclination of the display surface 15z5 of the display 15E, thereby enabling adjustment of the display direction to the eye direction of the driver hm. Also, while the cover part 11E is closed, the display direction of the display 15E is substantially perpendicular to the surface of the instrument panel 20, thereby substantially disabling the driver hm to visually recognize the display surface 15z5 of the display 15E. Further, in this state, nothing is displayed on the display 15D. That is, the display 15E is in a state where it substantially “cannot be visually recognized” by the driver hm.

In addition, while the cover part 11E is closed, an image of the same color or the same pattern as the instrument panel 20 there may also be displayed on the display 15E. This can make it harder for the driver hm to visually recognize the display 15E. Further, the cover part 110 may also be moved slightly upward in FIG. 11 to thereby direct the display direction of the display 15E forwardly of the vehicle This makes it still harder for the driver hm to visually recognize the display surface 15z5 of the display 15E.

### Other Embodiment

The invention is not limited within the above specific embodiments, various modifications corrections may be made without departing from the scope of the invention.

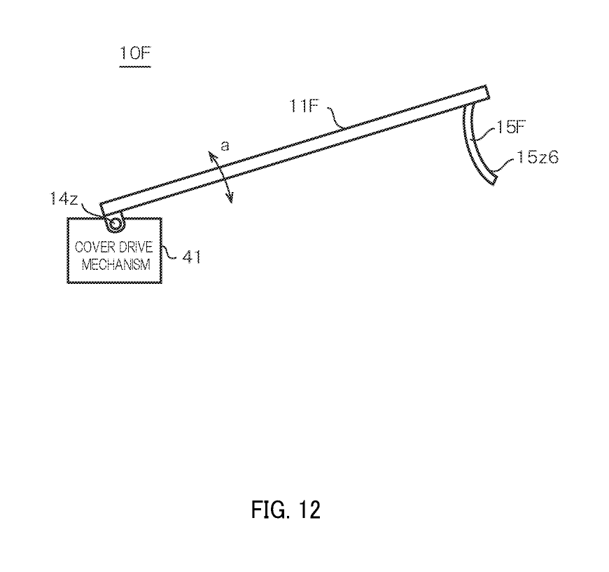

For example, in the first to third, fifth and sixth embodiments, the cover part and display are separated from each other, and the operation to open the cover part and the operation to incline the display are performed by different drive mechanisms. However, the cover part and display may also be connected to each other. For example, as shown in FIG. 12 (display apparatus 10F), when the display 15F is fixed to the rear end (in FIG. 12, the right end) of the cover part 11F, by changing the inclination angle of the cover part 11F, the position of the display 15F and the inclination of the display surface 15z6 can be changed. Thus, when the display direction (the inclination of a direction perpendicular to the display surface) of the display 15F is shifted from the eye direction of the driver hm, by adjusting the inclination angle of the cover part, the display direction can be adjusted to the eye direction of the driver hm. This can omit the display drive mechanism, thereby enabling simplification of the structure of the display apparatus.

Further, as the method for opening and closing the cover part, in the above respective embodiments, there has been shown the drive mechanism for rotating the cover part about the front end (vehicle forward side end) thereof. However, there may also be employed other various drive mechanisms including: for example, a slide-type drive mechanism in which, after the cover part is slightly moved up and down, it is moved horizontally; a lift-type drive mechanism which moves the cover part up and down while holding it in parallel; and, a gate-type drive mechanism which opens and closes the cover part in a manner to divide it to right and left sections in the center thereof.

In addition, the characteristics of the above embodiment of the vehicle display apparatus of the invention are described briefly as the following item (1) to (6).

(1) A vehicle display apparatus (10 to 10F) comprising:

a display part (15 to 15F) for use in a vehicle and displaying information; and

a cover part (11, 31) capable of switching its state between a first state not allowing the display part (15 to 15F) to be visually recognized by a vehicle driver (hm) and a second state allowing the display part (15 to 15F) to be visually recognized by the vehicle driver (hm).

(2) The vehicle display apparatus (10 to 10F) according to claim 1, wherein

the cover part (11, 31) constitutes a part of a surface of an instrument panel (20) of the vehicle and is capable of moving within a range from a first position (see FIG. 6B) where the surface and the cover part (11, 31) form a single flat surface to a second position (see FIG. 6A) where at least a portion of the cover part (11, 31) is separated from the surface; and

the display part (15 to 15F) is in the first state upon the cover part (11, 31) being at the first position (see FIG. 6B) and in the second state upon the cover part (11, 31) being at the second position (see FIG. 6A), the display part (15 to 15F) directing its display surface (15z to 15z6) in a direction corresponding to a viewpoint position of the vehicle driver (hm) upon being in the second state.

(3) The vehicle display apparatus (10 to 10F) according to claim 2, wherein

the display part (15 to 15F) is stored into the instrument panel (20) to be in the first state upon the cover part (11, 31) being at the first position (see FIG. 6B), and the display part (15 to 15F) is exposed from the instrument panel (20) to be in the second state upon the cover part (11, 31) being at the second position (see FIG. 6A).

(4) The vehicle display apparatus (10 to 10F) according to claim 1, wherein

the vehicle display apparatus (10 to 10F) determines, when the display part (15 to 15F) is in the first state, whether to switch the display part (15 to 15F) into the second state depending on the information to be displayed on the display part (15 to 15F).

(5) The vehicle display apparatus (10 to 10F) according to claim 4, wherein

the vehicle display apparatus (10 to 10F) determines to switch the display part (15 to 15F) into the second state when the information to be displayed on the display part (15 to 15F) is emergency information regarding an emergent state of the vehicle.

(6) The vehicle display apparatus (10 to 10F) according to claim 2, wherein

at least one of a position of the display part (15 to 15F) and a position of the cover part (11, 31) is adjusted to direct the display surface (15z to 15z6) in the direction corresponding to the viewpoint position of the vehicle driver (hm).

### REFERENCE SIGNS LIST

10 Display apparatus

11 Cover part

15 Display part (display)

20 Instrument panel

1. A vehicle display apparatus comprising:
a display part for use in a vehicle and displaying information; and
a cover part capable of switching its state between a first state not allowing the display part to be visually recognized by a vehicle driver and a second state allowing the display part to be visually recognized by the vehicle driver.

2. The vehicle display apparatus according to claim 1, wherein
the cover part constitutes a part of a surface of an instrument panel of the vehicle and is capable of moving within a range from a first position where the surface and the cover part form a single flat surface to a second position where at least a portion of the cover part is separated from the surface, and
the display part is in the first state upon the cover part being at the first position and in the second state upon the cover part being at the second position, the display part directing its display surface in a direction corresponding to a viewpoint position of the vehicle driver upon being in the second state.

3. The vehicle display apparatus according to claim 2, wherein
the display part is stored into the instrument panel to be in the first state upon the cover part being at the first position, and the display part is exposed from the instrument panel to be in the second state upon the cover part being at the second position.

4. The vehicle display apparatus according to claim 1, wherein
the vehicle display apparatus determines, when the display part is in the first state, whether to switch the display part into the second state depending on the information to be displayed on the display part.

5. The vehicle display apparatus according to claim 4, wherein
the vehicle display apparatus determines to switch the display part into the second state when the information to be displayed on the display part is emergency information regarding an emergent state of the vehicle.

6. The vehicle display apparatus according to claim 2, wherein
at least one of a position of the display part and a position of the cover part is adjusted to direct the display surface in the direction corresponding to the viewpoint position of the vehicle driver.
